(19) United States
(12) Patent Application Publication
(10) Pub. No.: US 2007/0103432 A1
(43) Pub. Date: May 10, 2007

(54) Optical sub-frame for interactive display system

(75) Inventors: Dawson Yee, Bellevue, WA (US); Glade Bacon, Everett, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/267,559

(22) Filed: Nov. 4, 2005

(51) Int. Cl. G09G 5/00

(52) U.S. Cl. 345/156

(57) ABSTRACT

An interactive display includes an optical sub-frame assembly and a sub-frame suspension that operates to isolate critical optical components of the interactive display from vibration and external forces applied to the interactive display. The optical sub-frame is affixed to the display surface and coupled to a frame of the interactive display via the sub-frame suspension to provide shock and vibration damping. The optical sub-frame assembly maintains optical alignment between optical devices such as a projector, one or more lenses, an illumination source, a display screen, and a light detector. The optical components of the interactive display are thus supported by the optical sub-frame, such that vibration and external forces applied to the interactive display are much less likely to affect the optical performance of the interactive display.

### BACKGROUND

The utility of computer systems can be enhanced by providing better user interfaces. User interfaces for computers systems have evolved significantly since the personal computer (PC) first became widely available. Early PCs used rather primitive user input devices, such as the serial mouse. However, the vast improvement in speed and power of microprocessors, the available memory, and programming functionality have all contributed to the advancement of user interface design and the development of user-friendly graphic operating systems and hardware.

One particular area of advancement in user interface technology pertains to the recent development of interactive displays, to which a number of commonly assigned patent applications have been directed. An interactive display presents graphic images to a user on a flat surface, such as the top of a table. A PC is coupled to the interactive display to provide the processing power that yields a rich user interactive experience, offering more sophisticated command and interface features, and a far more natural interactive approach in providing input to the system related to displayed images. Interactive display systems that have been developed employ an optical system disposed within a rigid housing for generating images, and for detecting user input. However, such optical systems usually have close operational tolerances with regard to maintaining a fixed relationship between projected images and the portion of the system that detects input. There is concern that although an interactive display system might be properly adjusted and calibrated when manufactured, shipping and other causes may shift the relative disposition of the optical components in the housing so that the calibration and proper adjustment of the optical components will be lost.

Another concern is that when such systems become commercially available, an interactive display employed in a public facility may be subjected to substantial external forces from users leaning on, climbing over, or sitting upon the display's surface. Such forces can affect the alignment of the optical system, causing image distortion and errors in sensing the position of objects on or near the display surface, relative to the image. Furthermore, in rare circumstances, such forces can permanently deflect a portion of the interactive display housing and affect the optical alignment of the display. Additionally, a rigid display housing usually provides minimal resistance to vibration, shock forces, and other environmental disturbances. Therefore, it has become more important to ensure that deflections of the interactive display case or surface or other environmental disturbances will not adversely impact the performance of the interactive display system.

### SUMMARY

Several embodiments of an interactive display are described in more detail below. In at least one of the implementations discussed, the interactive display includes a number of components, such as a display body, a display surface, an optical sub-frame assembly, and a sub-frame suspension. In at least one such embodiment, the optical sub-frame is affixed to the display surface and coupled to the display body via the sub-frame suspension. The optical sub-frame assembly provides a controlled optical alignment for one or more optical devices such as a projector, one or more lenses, an illumination source, a display screen, and a light detector. The devices are supported by the optical sub-frame, so that external forces, such as shock and vibration, are much less likely to affect the optical performance of the interactive display by changing the disposition of these device relative to each other.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a cross-sectional view illustrating internal components of an interactive display table system that includes an integral PC, but does not employ the present approach discussed below;

FIG. 2 is an isometric view of an embodiment in which an interactive display table, which may include an embodiment of the present suspended optical sub-frame, is connected to an external PC;

FIG. 3 is a schematic cross-sectional illustration of an interactive display table that includes an exemplary embodiment of a suspended optical sub-frame assembly; and

FIG. 4 is an isometric sectional illustration of an interactive display that includes an embodiment of the suspended optical sub-frame.

### DESCRIPTION

Figures and Disclosed Embodiments Are Not Limiting

Exemplary embodiments are illustrated in referenced Figures of the drawings. It is intended that the embodiments and Figures disclosed herein are to be considered illustrative rather than restrictive.

Interactive Display System

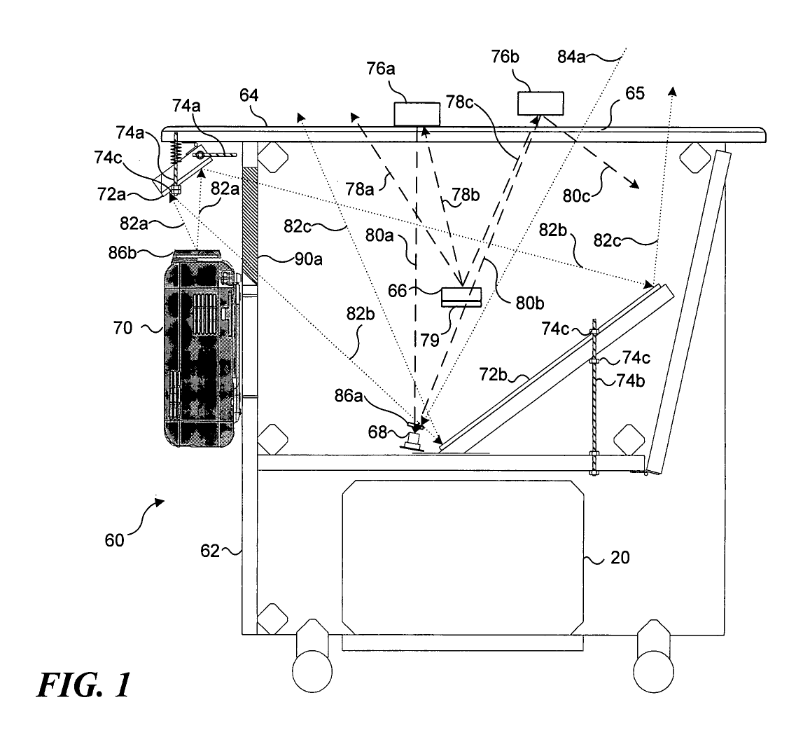

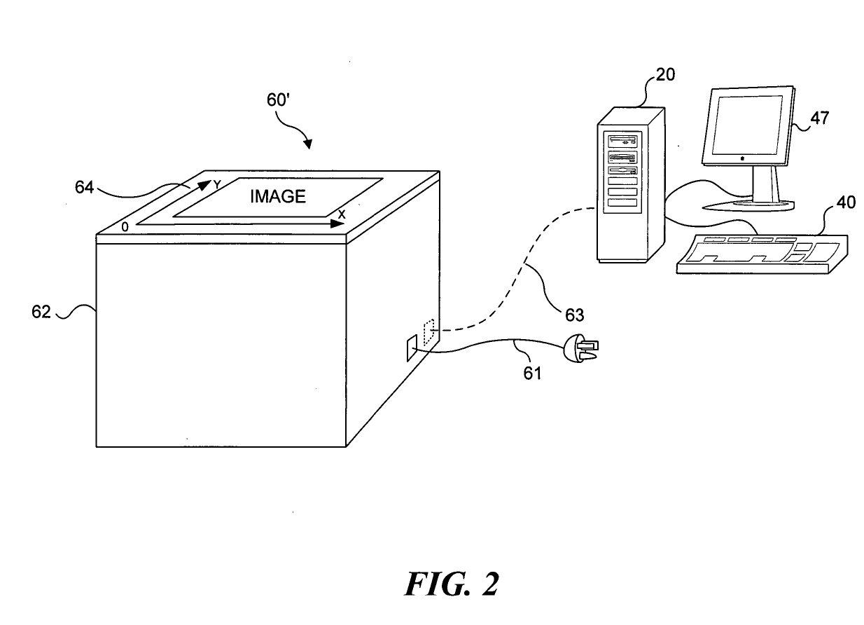

In FIG. 1, an exemplary interactive display table 60 is shown that includes a personal computer (PC) 20 within a frame 62 and which serves as both an optical input and video display device for the PC. This embodiment of the interactive display table does not include a suspended optical sub-frame. This embodiment is shown for comparison to the exemplary embodiments of FIGS. 2 through 4 that do include the novel suspended optical sub-frame. Also, this Figure should help to clarify how the interactive display system operates to both display images on an interactive display surface, as well as detecting objects that are on or adjacent to the interactive display surface.

In this cut-away Figure of interactive display table 60, rays of light 82a-82c used for displaying text and graphic images are generally illustrated using dotted lines, while rays of infrared (IR) light used for sensing objects on or just above a display surface 64 of interactive display table 60 are illustrated using dash lines. The perimeter of the table surface around the actual display area in the center is useful for supporting a user's arms or other objects, including objects that may be used to interact with the graphic images or virtual environment being displayed on display surface 64.

IR light sources 66 preferably comprise a plurality of IR light emitting diodes (LEDs) and are mounted on the interior side of frame 62. The IR light that is produced by IR light sources 66 is directed upwardly toward the underside of display surface 64, as indicated by dash lines 78a, 78b, and 78c. The IR light from IR light sources 66 is reflected from any objects that are atop or proximate to the display surface after passing through a translucent layer 65 of the table, comprising a sheet of vellum or other suitable translucent material with light diffusing properties. As used herein and in the description that follows in connection with objects positioned on or proximate to the interactive display surface, the term “adjacent to” is used with the intention that this term encompass both an object that is actually touching the interactive display surface as well as one that is just above the interactive display surface. Although only one IR source 66 is shown, it will be appreciated that a plurality of such IR sources may be mounted at spaced-apart locations around the interior sides of frame 62 to provide an even illumination of display surface 64. The IR light produced by the IR sources may:
exit through the table surface without illuminating any objects, as indicated by dash line 78a;
illuminate objects on the table surface, as indicated by dash line 78b; or
illuminate objects a short distance above the table surface but not touching the table surface, as indicated by dash line 78c.

Objects above display surface 64 include a “touch” object 76a that rests atop the display surface and a “hover” object 76b that is close to but not in actual contact with the display surface. Thus, both touch and hover objects are “adjacent to” the display surface, as that term is used herein. As a result of using translucent layer 65 to diffuse the IR light passing through the display surface as an object approaches the top of display surface 64, the amount of IR light that is reflected by the object increases to a maximum level that is achieved when the object is actually in contact with the display surface.

A digital video camera 68 is mounted to frame 62 below display surface 64 in a position appropriate to receive IR light that is reflected from any touch object or hover object disposed above display surface 64. Digital video camera 68 is equipped with an IR pass filter 86a that transmits only IR light and blocks ambient visible light traveling through display surface 64 along dotted line 84a. In the illustrated implementation, a baffle 79 is disposed between IR source 66 and digital video camera 68 to prevent IR light that is directly emitted from the IR source from entering the digital video camera. It is preferable that the digital video camera should produce an output signal that is only responsive to the IR light reflected from objects that are a short distance above or in contact with display surface 64. In this manner, only light that corresponds to an image of IR light reflected from objects on or above the display surface will be detected. It will be apparent that digital video camera 68 will also respond to any IR light included in the ambient light that passes through display surface 64 from above and into the interior of the interactive display, including ambient IR light that also travels along the path indicated by dotted line 84a .

IR light reflected from objects on or above the table surface may be reflected back through translucent layer 65, through IR pass filter 86a and into the lens of digital video camera 68, as indicated by dash lines 80a and 80b or reflected or absorbed by other interior surfaces within the interactive display without entering the lens of digital video camera 68, as indicated by dash line 80c .

Translucent layer 65 diffuses both incident and reflected IR light. Thus, as explained above, “hover” objects such as hover object 76b that are closer to display surface 64 will reflect more IR light back to digital video camera 68 than objects of the same reflectivity that are farther away from the display surface. Digital video camera 68 senses the IR light reflected from “touch” and “hover” objects within its imaging field and produces a digital signal corresponding to images of the reflected IR light that is input to the PC 20 for processing to determine a location of each such object, and optionally, the size, orientation, and shape of the object. It should be noted that a portion of an object, such as a user's forearm, may be above the table while another portion, such as the user's finger, is in contact with the display surface. In addition, an object may include an IR light reflective pattern or coded identifier, such as a bar code, on its bottom surface that is specific to that object or to a class of related objects of which that object is a member. Accordingly, the imaging signal from the digital video camera 68 can also be used for detecting each such specific object, as well as determining its orientation, based on the IR light reflected from its reflective pattern, in accord with the present invention.

The illustrated interactive display table is operable to recognize an object and/or its position relative to the interactive display surface 64 by detecting its identifying characteristics using the IR light reflected from the object. The logical steps implemented to thus detect and identify an object and its orientation are explained in the commonly-assigned patent applications, including application Ser. No. 10/814,577 entitled “Identification Of Object On Interactive Display Surface By Identifying Coded Pattern,” and application Ser. No. 10/814,761 entitled “Determining Connectedness And Offset Of 3D Objects Relative To An Interactive Surface,” both of which were filed on Mar. 31, 2004.

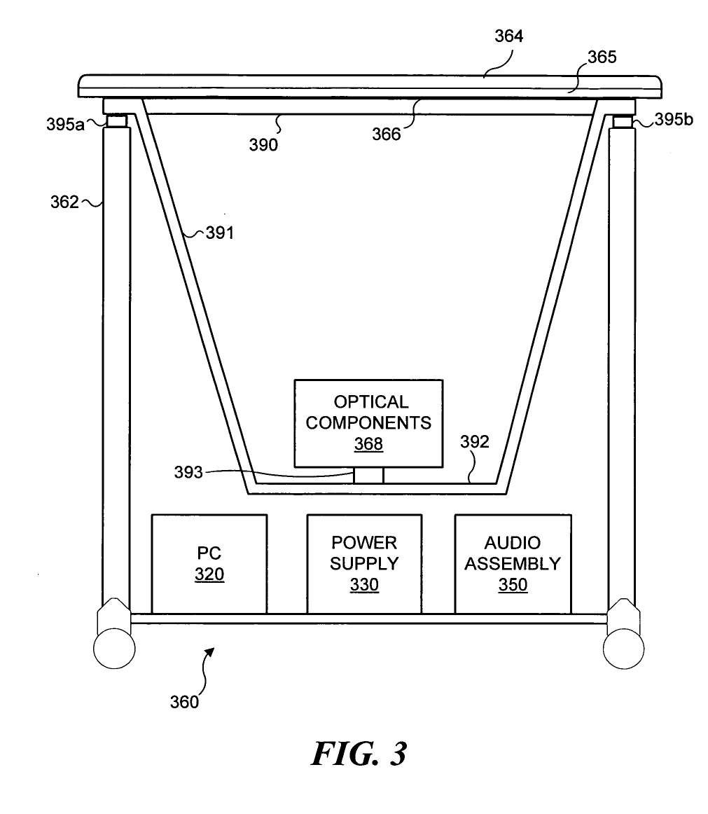

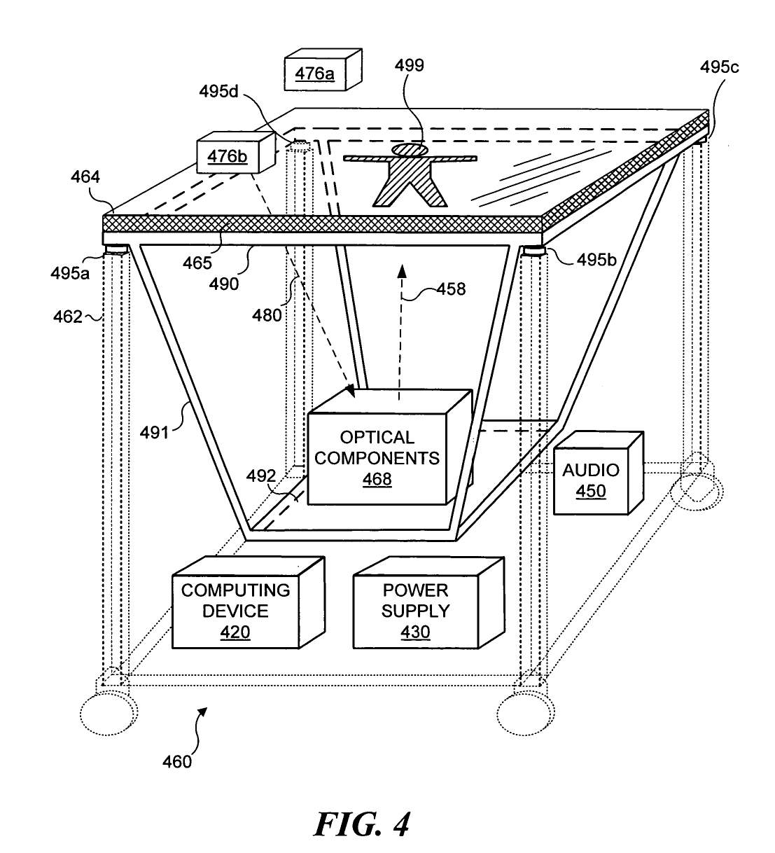

PC 20 may be integral to interactive display table 60 as shown in FIG. 1, or alternatively, may instead be external to the interactive display table, as shown in the embodiment of FIG. 2. In FIG. 2, an interactive display table 60′ is connected through a data cable 63 to an external PC 20 (which includes optional monitor 47, as mentioned above). The embodiment of FIG. 2 may include the suspended optical sub-frame, details of which are discussed below in connection with FIGS. 3 and 4. External PC 20 can be connected to interactive display table 60′ via a wireless link (i.e., WiFi or other appropriate radio signal link). As also shown in this Figure, a set of orthogonal X and Y axes are associated with display surface 64, as well as an origin indicated by “0.” While not discretely shown, it will be appreciated that a plurality of coordinate locations along each orthogonal axis can be employed to specify any location on display surface 64.

If an interactive display table 60′ is connected to an external PC 20 (as in FIG. 2) or to some other type of external computing device, such as a set top box, video game, laptop computer, or media computer (not shown), then interactive display table 60′ comprises an input/output device. Power for interactive display table 60′ is provided through a power lead 61, which is coupled to a conventional alternating current (AC) source (not shown). Data cable 63, which connects to interactive display table 60′, can be coupled to a USB 2.0 port, an Institute of Electrical and Electronics Engineers (IEEE) 1394 (or Firewire) port, or an Ethernet port on PC 20. It is also contemplated that as the speed of wireless connections continues to improve, interactive display table 60′ might also be connected to a computing device, such as PC 20 via such a high speed wireless connection, or via some other appropriate wired or wireless data communication link. Whether included internally as an integral part of the interactive display, or externally, PC 20 executes algorithms for processing the digital images from digital video camera 68 and executes software applications that are designed to employ the more intuitive user interface functionality of the interactive display table to good advantage, as well as executing other software applications that are not specifically designed to make use of such functionality, but can still make good use of the input and output capability of the interactive display table. As yet a further alternative, the interactive display can be coupled to an external computing device, but include an internal computing device for doing image processing and other tasks that would then not be done by the external PC.

An important and powerful feature of the interactive display table is its ability to display graphic images or a virtual environment for games or other software applications and to enable an interaction between the graphic image or virtual environment visible on display surface 64 and identify objects that are resting atop the display surface, such as an object 76a, or are hovering just above it, such as an object 76b.

Again referring to FIG. 1, interactive display table 60 includes a video projector 70 that is used to display graphic images, a virtual environment, or text information on display surface 64. The video projector is preferably of a liquid crystal display (LCD) or digital light processor (DLP) type, or a liquid crystal on silicon (LCoS) display type, with a resolution of at least 640×480 pixels. An IR cut filter 86b is mounted in front of the projector lens of video projector 70 to prevent IR light emitted by the video projector from entering the interior of the interactive display table where the IR light might interfere with the IR light reflected from object(s) on or above display surface 64. Video. projector 70 projects light along dotted path 82a toward a first mirror assembly 72a. First mirror assembly 72a reflects projected light from dotted path 82a received from video projector 70 along dotted path 82b through a transparent opening 90a in frame 62, so that the reflected projected light is incident on a second mirror assembly 72b. Second mirror assembly 72b reflects light from dotted path 82b along dotted path 82c onto translucent layer 64b, which is at the focal point of the projector lens, so that the projected image is visible and in focus on display surface 64 for viewing.

Alignment devices 74a and 74b are provided and include threaded rods and rotatable adjustment nuts 74c for adjusting the angles of the first and second mirror assemblies to ensure that the image projected onto the display surface is aligned with the display surface. In addition to directing the projected image in a desired direction, the use of these two mirror assemblies provides a longer path between projector 70 and translucent layer 64b to enable a longer focal length (and lower cost) projector lens to be used with the projector.

The foregoing discussions describe an interactive display device in the form of interactive display table 60 (or alternatively, of interactive display table 60′). Nevertheless, it is understood that the interactive display surface need not be in the form of a generally horizontal table top. The principles described in this description of the invention suitably also include and apply to display surfaces of different shapes and curvatures and that are mounted in orientations other than horizontal. Thus, although the following description refers to placing physical objects “on” the interactive display surface, physical objects may be placed adjacent to the interactive display surface by placing the physical objects in contact with the display surface or otherwise adjacent the display surface. It should be appreciated that the exemplary display systems described above in connection with FIGS. 1 and 2 are not limited to any specific type of display or sensing technology, and are merely provided as exemplary implementations of various interactive display systems in order to demonstrate an operating environment and common components used with other specific interactive display implementations as will be further discussed below.

FIG. 3 is a schematic cross-sectional illustration of an interactive display table 360 that includes a suspended optical sub-frame assembly 390. Interactive display table 360 generally includes a display housing having a housing frame 362 which supports an optical sub-frame assembly 390. The optical sub-frame assembly is supported by housing frame 362 using a compliant suspension system, which is illustrated by way of suspension components 395a and 395b. Optical sub-frame assembly 390 includes a support frame, illustrated as a frame 391, and a structural support, illustrated as an optical component platform 392. The optical component platform is a structural support for one or more optical components 368.

A display screen surface 364 is affixed to sub-frame assembly 390. In some implementations, display screen surface 364 can be attached to optical sub-frame assembly 390 with various permanent or removable attachment means, including: adhesives, epoxies, silicones, polymers, threaded fasteners, cam locks, and the like. Display screen surface 364 can include a light diffusing layer 365. Furthermore, in one implementation, an IR-sensitive area detector 366 (e.g., pixilated light sensors capable of detecting IR light reflected from objects disposed adjacent to or on display screen surface 364—at up to pixel resolution) can also be affixed, or disposed adjacent to, display screen surface 364. If IR-sensitive area detector 366 is employed, the video camera object sensing approach discussed in connection with interactive display table 60 in FIG. 1 will not be required. Generally, the display screen surface comprises one or more acrylic plastic sheets having specifically selected optical and tactile properties, although sheets of other types of plastic, glass, or other optically transparent materials can be employed for this component.

Suspension components 395a and 395b are at least formed of an elastomeric material, such as natural or synthetic rubber or silicone. More broadly, these suspension components represent any of a variety of suspension devices including: viscoelastic polymers, fluid-filled bladders, various types of springs or torsion bars, magnetic dampers, and actively driven suspension dampers, such as motor-driven and solenoid-actuated devices, and the like, without limitation. Suspension components 395a and 395b are selected to provide shock and vibration isolation, as well as a substantial compliance to forces associated with a user leaning on, climbing on, or sitting upon a display surface. Since these forces can vary widely, depending upon the weight of the user and the environment in which the interactive display table is used, it is expected that the suspension component compliance and damping properties will be specified as a function of the intended user, and as a function of the environment in which the interactive display table will be used.

Interactive display table 360 can also include other components such as a PC 320 (which may alternatively be external, as shown in connection with interactive display table 60′ in FIG. 2), a power supply 330 for providing power to various components of interactive display 360, and an audio assembly 350 that can include a preamplifier, amplifier, and other devices for producing sound in response to a sound signal input from PC 320. It should be noted that while each of the foregoing components is coupled to and/or directly supported by housing frame 362 of the interactive display, optical components 368 are supported by optical sub-frame assembly 390, which is decoupled from housing frame 362 by suspension components illustrated by 395a and 395b. Optical components 368 can be any of a variety of optical components that make up an optical subsystem of the interactive display table, as discussed above with reference to FIGS. 1-2. For example, optical components 368 can include a projector, one or more lenses, an IR illumination source, and various IR light detector components, such as a video camera, that function to provide an image and detect objects on or adjacent to display screen surface 364, as discussed above. In one implementation, optical components 368 are optionally further decoupled from optical sub-frame assembly 390 with a suspension device 393.

Optical sub-frame assembly 390 ensures that a fixed optical relationship is retained between optical components 368 and display screen surface 364. Therefore, a force applied on display screen surface 364 will be transferred to suspension components 395a and 395b, which are generally configured to deflect under the force, while the rigid frame of sub-frame assembly 390 maintains the optical alignment between optical components 368 and display screen surface 364. Sub-frame assembly 390 can be constructed of any suitably rigid material depending upon the specific requirements of the intended application. For example, while not an exhaustive list: metals and metal alloys including steel, titanium, magnesium, and various aluminum alloys; cellulose-fiber composites such as hardboard; fiberglass, fiber composites, and polymers are all suitable materials. Support frame 391 can be any shape or size suitable for supporting display screen surface 364 and optical components 368, depending upon the size and shape of the interactive display table with which it is used. In the implementation illustrated in FIG. 3, support frame 391 is defined by the vertices and the edges of a six-sided polyhedron, forming a rigid structural framework along the outer edges of the polyhedron.

FIG. 4 is an isometric sectional illustration of an interactive display table 460 corresponding to interactive display table 360 in FIG. 3, and which includes a suspended optical sub-frame assembly 490. As illustrated in FIG. 4, an interactive display surface 464 provides both a display surface for displayed objects such as image 499, and as a reference for user input by positioning or moving objects such as a touch object 476b that is in contact with the display surface, and a hover object 476a, which is disposed slightly above (adjacent to) the display surface. The interactive display surface can also include a light diffusing layer 465. Interactive display surface 464 can be attached to suspended optical subsystem 490 with any form of permanent or removable attachment, such as viscoelastic polymers, adhesives, epoxies, threaded fasteners, cam locks, and the like. As illustrated in FIG. 4, optical components 468 are configured to project image 499, as illustrated by ray 458, and detect hover and touch objects such as hover and touch objects 476b and 476a, as illustrated by ray 480. Optical sub-frame assembly 490 includes a support frame 491 and a component platform 492.

As illustrated in FIG. 4, support frame 491 is coupled to a housing frame 462 via four suspension dampers 495a-495d. In other implementations (not shown), support frame 491 is coupled to housing frame 462 via a continuous suspension assembly that extends along a perimeter of support frame 491. In yet other implementations, which are also not shown, less than or greater than four suspension dampers can be employed to couple the support frame to the interactive display frame. Dampers 495a-495d can be formed of an elastomeric material or may comprise any suitable suspension device, such as those discussed above with reference to FIG. 3. In some implementations, dampers 495-495d may differ in design and material properties from one another in order to achieve specific design goals depending upon the intended use and the likely environment in which the interactive display table will be used. Support frame 491 can be fabricated of any suitable rigid material, as discussed above, with reference to FIG. 3. Interactive display table 460 includes additional components, including a computing device 420 (which may alternatively be external), a power supply 430 and an audio assembly 450, which function like the corresponding components described above, with reference to FIG. 3.

Another aspect of this development is directed to an exemplary method for configuring an interactive display table. This method includes the step of providing an optical subsystem for the interactive display table. In this implementation, the optical subsystem is separately supported so as to maintain the optical alignment of optical components used in the interactive display table even when the interactive display table is subjected to an externally applied force, or if subjected to vibration or moderate shock. The method includes coupling an optical sub-frame assembly to a housing of the interactive display table with one or more suspension dampers. The suspension dampers decouple the optical subsystem from the housing frame of the interactive display table in order to provide some vibration isolation and damping and to enable compliance to externally applied force.

Another step of this method provides that the optical sub-frame assembly for the interactive display be formed of substantially rigid members for mounting one or more optical components in a substantially fixed optical alignment with each other.

Still another step of the method provides for coupling the optical components to the optical sub-frame assembly with a damper to at least partially decouple the optical components from the optical sub-frame assembly, thereby providing even more shock and vibration isolation to the optical components.

Although the present novel approach has been described in connection with the preferred forms of practicing it and modifications thereto, those of ordinary skill in the art will understand that many other modifications can be made within the scope of the claims that follow. Accordingly, it is not intended that the scope of the protection for this approach in any way be limited by the above description, but instead be determined entirely by reference to the claims that follow.

The invention in which an exclusive right is claimed is defined by the following:

1. An optical sub-assembly for use in an interactive display, the optical sub-assembly comprising:
(a) an optical component;
(b) a display screen surface;
(c) an optical component support, the optical component support comprising:
(i) a support frame; and
(ii) a component platform affixed to the support frame, the component platform being configured to support the optical component in a substantially fixed optical alignment with the display screen surface, wherein the display screen surface is affixed to the support frame; and
(d) at least one suspension component for at least partially decoupling the optical component support from a housing of the interactive display when the optical component support is assembled with the housing.

2. The optical sub-assembly of claim 1, wherein the support frame comprises a polyhedron defined by a plurality of support members to form a substantially rigid structural frame.

3. The optical sub-assembly of claim 1, wherein the support frame is composed at least in part from at least one of:
(a) steel;
(b) an aluminum alloy;
(c) magnesium;
(d) a cellulose-fiber composite;
(e) fiberglass;
(f) a carbon-fiber composite; and
(g) a polymer.

4. The optical sub-assembly of claim 1, wherein the suspension component comprises at least one of:
(a) viscoelastic polymer;
(b) a fluid-filled bladder;
(c) a spring;
(d) a torsion bar;
(e) a magnetic damper;
(f) rubber;
(g) silicone; and
(h) an actively driven suspension damper.

5. The apparatus of claim 1, wherein the display screen surface is affixed to the support frame with a removable attachment.

6. The apparatus of claim 1, wherein the optical component comprises at least one of:
(a) a projector;
(b) a lens;
(c) an illumination source; and
(d) a light detector.

7. The apparatus of claim 1, further comprising a light diffusing layer affixed to the display screen.

8. The apparatus of claim 1, further comprising an IR-sensitive area light detector that is affixed to the display screen.

9. The apparatus of claim 1, further comprising an optical component suspension for at least partially decoupling the optical component from the component platform.

10. An interactive display, the interactive display comprising:
(a) a display body;
(b) a display surface;
(c) a optical sub-flame suspension; and
(d) an optical sub-frame assembly affixed to the display surface and coupled to the display body via the sub-frame suspension, the optical sub-frame assembly maintaining an optical alignment between the display surface and at least one optical device supported by the optical sub-frame.

11. The interactive display of claim 10, wherein the display surface includes a light diffuser.

12. The interactive display of claim 10, wherein the optical sub-frame assembly comprises:
(a) a substantially rigid frame; and
(b) at least one structural support affixed to the frame, the at least one structural support supporting the optical component in a fixed optical alignment with respect to the display surface.

13. The interactive display of claim 10, wherein the optical sub-frame is configured for removable coupling to the display body with the optical sub-frame suspension.

14. The interactive display of claim 10, further comprising an optical device including at least one of:
(a) a projector;
(b) a lens;
(c) an illumination source; and
(d) a light detector.

15. The interactive display of claim 10, further comprising at least one of:
(a) a computing device, the computing device being configured for electrical communication with an optical component;
(b) an audio assembly; and
(c) a power supply.

16. The interactive display of claim 10, wherein the sub-frame suspension comprises at least one of:
(a) viscoelastic polymer;
(b) a fluid-filled bladder;
(c) a spring;
(d) a torsion bar;
(e) a magnetic damper; and
(f) an actively driven suspension damper.

17. The interactive display of claim 10, further comprising an optical device damper for providing isolation for an optical device supported by the optical sub-frame assembly.

18. A method for configuring an interactive display, comprising the steps of:
(a) providing an optical sub-system for the interactive display wherein the optical sub-system substantially maintains an optical alignment between components of the interactive display when the interactive display is subjected to an externally applied force that would otherwise cause an optical misalignment between the components; and
(b) damping movement between the optical sub-system and the frame of the interactive display to at least partially decouple the optical subsystem from vibration and external force applied to the frame.

19. The method of claim 18, wherein the step of providing an optical sub-system for the interactive display comprises the step of providing a substantially rigid optical sub-frame for mounting the components in a substantially fixed optical alignment with each other.

20. The method of claim 18, further comprising the step of damping movement between the components and an optical sub-frame that supports the components, to at least partially decouple the components from the optical sub-frame.
